(19) United States
(12) Patent Application Publication
(10) Pub. No.: US 2019/0267668 A1
(43) Pub. Date: Aug. 29, 2019

(54) METHOD OF AN IONIC CONDUCTING LAYER

(71) Applicant: CHUNGANG UNIVERSITY INDUSTRY ACADEMIC COOPERATION FOUNDATION, Seoul (KR)

(72) Inventors: Myung Gil KIM, Seoul (KR); Seung Woo YU, Seoul (KR)

(73) Assignee: CHUNGANG UNIVERSITY INDUSTRY ACADEMIC COOPERATION FOUNDATION, Seoul (KR)

(21) Appl. No.: 16/327,530

(22) PCT Filed: Jun. 28, 2017
(86) PCT No.: PCT/KR2017/006850

§ 371 Date: May 7, 2019

(30) Foreign Application Priority Data
Jun. 30, 2016 (KR) 10-2016-0082490

(51) Int. Cl. H01M 10/0562; H01M 10/0525; C09D 5/24

(52) U.S. Cl. CPC H01M 10/0562; H01M 2300/0071; C09D 5/24; H01M 10/0525

(57) ABSTRACT

A method for producing an ionic conductive film is disclosed. The method includes preparing a precursor solution, wherein the precursor solution contains a framework compound having a single bond or double bond between phosphorus (P) and nitrogen (N), a metal salt compound, and an organic solvent; preforming a solution process of the precursor solution in a non-vacuum condition to form a precursor film on a base; and preforming a heat-treating process of the precursor film to form a coated film containing metal-phosphorus-oxynitride.

### TECHNICAL FIELD

The present disclosure relates to a method for producing an ionic conductive film, and more particularly to a method for producing an ionic conductive film containing metal-phosphorus-oxynitride and a derivative thereof.

### BACKGROUND

Lithium ion conductive solid electrolytes have excellent stability, long life, high mechanical rigidity, and fast charge and discharge, and the like in various fields such as thin film secondary batteries, fast-charged secondary batteries, and super capacitors, etc. Those properties may be not realized by the conventional liquid electrolytes.

Among various compounds such as a sulfide metal compound, a crystalline oxide, and a lithium nitride as solid electrolyte, lithium-phosphor-oxynitride (LIPON) is a compound with a high ionic conductivity of 2×10⁻⁶ cm²/Vs or higher. The LIPON is known as an optimal lithium ionic conductive solid electrolyte because the LIPON has sufficient mechanical rigidity to prevent growth of lithium dendrite and the LIPON has uniform physical properties and mechanical flexibility exhibited by an amorphous based material.

A method for producing the LIPON film may involve a reactive sputtering method as an expensive vacuum process using a Li₃PO₄ target and a nitrogen plasma, by which the LIPON film is produced at a temperature of about 100 to 150° C. In the resulting film, a nitrogen atom is contained in the Li₃PO₄ matrix. In this connection, the nitrogen atom acts to bonding 2 or 3 phosphorus atoms, so that the mechanical stability of the LIPON film and the ionic conductivity of lithium can be improved. However, since the sputtering method is a vacuum process based on physical evaporation, the sputtering equipment itself is expensive, and the production process is costly.

In order to replace the sputtering method, atomic layer deposition (ALD) or metal organic chemical vapor deposition (MOCVD) is employed. However, the LIPON film as produced by this method exhibits a low conductivity of 10⁻⁷ S/cm or lower. Further, there is a problem that the process must be carried out at a high temperature of at least 500° C. or higher.

Therefore, there is a desperate need for a method for producing a new LIPON film which may secure the excellent ionic conductivity and the like while replacing the expensive vacuum process.

### DISCLOSURE

### Technical Purpose

One purpose of the present disclosure is to solve the conventional problems as described above and thus to provide a method for producing an ionic conductive film, in which the method is capable of producing an ionic conductive film having excellent characteristics via a simple process in a non-vacuum condition.

### Technical Solution

In one aspect of the present disclosure, there is provided a method for producing an ionic conductive film, the method comprising: preparing a precursor solution, wherein the precursor solution contains a framework compound having a single bond or double bond between phosphorus (P) and nitrogen (N), a metal salt compound, and an organic solvent; preforming a solution process of the precursor solution in a non-vacuum condition to form a precursor film on a base; and preforming a heat-treating process of the precursor film to form a coated film containing metal-phosphorus-oxynitride.

In one embodiment, the solution process includes coating the precursor solution on the base using at least one selected from a group consisting of spray coating, spin coating, dip coating, inkjet printing, offset printing, reverse offset printing, gravure printing and roll printing.

In one embodiment, the method further comprises, after preparing the precursor solution and before the solution process, heating the precursor solution.

In one embodiment, the heat-treating process is carried out at a temperature in a range of from 150° C. to 500° C.

In one embodiment, each of the solution process and the heat-treating process is carried out under a dry air atmosphere or an inert gas atmosphere.

In one embodiment, the method further comprises, before the heat-treating process, removing the organic solvent from the precursor film by heating the precursor film to a temperature lower than a temperature of the heat-treating process.

In one embodiment, the base includes a particulate substrate, a three-dimensional porous structure or a plate-like substrate.

In one embodiment, a cycle including the solution process and the heat-treating process is repeated such that a plurality of the coated films are stacked vertically.

In one embodiment, the coated film has an amorphous phase containing a phosphorus (P)-oxygen (O)-phosphorous (P) bond and a phosphorus (P)-nitrogen (N)-phosphorous (P) bond.

In one embodiment, the preparation of the precursor solution includes mixing a chalcogen compound with the framework compound, the metal salt compound and the organic solvent to form the precursor solution, wherein the coated film contains the metal-phosphorus-oxynitride, and metal-phosphorus-chalcogen nitride. In one embodiment, the coated film has an amorphous phase containing a phosphorus (P)-oxygen (O)-phosphorous (P) bond, a phosphorus (P)-nitrogen (N)-phosphorous (P) bond, and a phosphorus (P)-chalcogen element (C)-phosphorous (P) bond.

### Technical Effect

According to the method for producing the ionic conductive film in accordance with the present disclosure as described above, a high-performance ionic conductive film containing metal-phosphorus-oxynitride and/or its derivatives may be easily and rapidly produced via a solution process in a non-vacuum condition. Accordingly, the production cost of the ionic conductive film is lowered, and the production time is shortened, such that a productivity can be significantly improved. According to the method for producing the film in accordance with the present disclosure, the ionic conductive film may be easily formed on various substrates, for example, made of a metal, a plastic, a paper, a textile, or on various anode or cathode particles. The metal-phosphorus-oxynitride film as produced acts as an excellent ionic conductive film.

### BRIEF DESCRIPTION OF DRAWINGS

FIG. 1 is a flow chart for illustrating a method for producing an ionic conductive film according to an embodiment of the present disclosure.

FIG. 2 is a cross-sectional view of a capacitor for illustrating a method for producing the capacitor according to one embodiment of the present disclosure.

FIG. 3 shows atomic force microscope images of a sample 1 to a sample 4 as produced according to the present disclosure.

FIG. 4 shows impedance measurements of capacitors as produced using the samples 1, 2, 4 and 5 as produced according to the present disclosure.

FIG. 5 and FIG. 6 show structural analysis results of the sample 1 and sample 5 as produced according to the present disclosure.

FIG. 7 shows N 1s analysis results of a sample 6 and a sample 7 as produced according to the present disclosure.

FIG. 8 shows a result of X-ray diffraction analysis for the sample 7 as produced according to the present disclosure.

FIG. 9 shows results of structural analysis of a sample 9 as produced according to the present disclosure.

FIG. 10 shows an impedance measurement of a capacitor fabricated using a sample 10 as produced according to the present disclosure.

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. The same reference numbers in different figures denote the same or similar elements, and as such perform similar functionality.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, as used herein, a term “alkyl group” is defined to include not only a linear type but also an isomeric branched type.

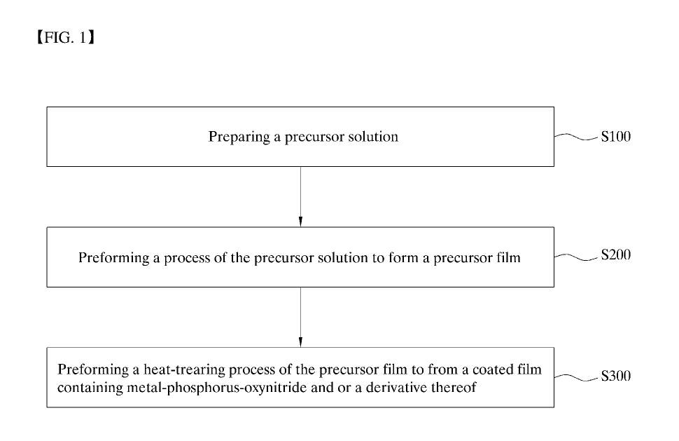

FIG. 1 is a flow chart for illustrating a method for producing an ionic conductive film according to an embodiment of the present disclosure.

Referring to FIG. 1, in one embodiment of a method for producing an ionic conductive film, a precursor solution containing metal-phosphorus-oxynitride or a derivative thereof is prepared (S100).

The precursor solution may include a framework compound containing a phosphorus-nitrogen bond, a metal salt compound providing a metal ion, and an organic solvent.

The framework compound is a compound containing a phosphorus-nitrogen bond. The framework compound may be a single molecule, a polymer or a mixture thereof. The bond between phosphorus and nitrogen may be a single bond and/or a double bond. The framework compound provides for a support structure as a framework (matrix) composed of P—N—O of the metal-phosphorus-oxynitride. The framework compound includes a mono-molecular phosphazene compound or a poly-phosphazene compound.

Examples of the framework compound include a monomolecular compound represented by a following formula a-1 or a-2 and/or a polymer compound containing a monomer represented by a following formula a-3. The monomolecular compound and polymer compound may be used independently, or combinations of two or more of the monomolecular compounds and polymer compounds may be used.

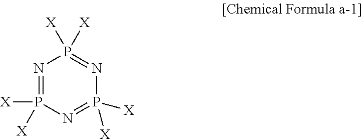

In the Chemical Formula a-1, X represents —OR, F, Cl, Br or I. In this connection, R represents an alkyl group having 1 to 5 carbon atoms.

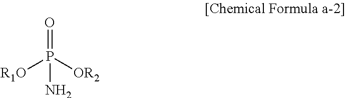

In Chemical Formula a-2, each of R1 and R2 independently represents an alkyl group having 1 to 10 carbon atoms or an aryl group having 6 to 12 carbon atoms.

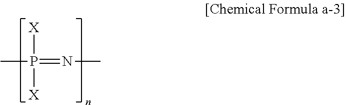

In Chemical Formula a-3, X represents —OR, R, NR₁R₂, F, Cl, Br or I. n represents an integer between 100 and 100,000. Each of R, R₁ and R₂ in X independently represents hydrogen, an alkyl group having 1 to 10 carbon atoms or an aryl group having 6 to 12 carbon atoms. For example, for a polymer containing a monomer represented by the Chemical Formula a-3, n may be in a range of 10,000 to 20,000.

The metal salt compound may be a salt containing a monovalent metal ion (Li⁺, Na⁺), a divalent metal ion (Mg²⁺) or a trivalent metal ion (Al³⁺), and may have various forms such as halides, hydroxides, acetic oxides, alkoxides and the like. In one example, the metal salt may be a lithium salt containing a lithium ion (Li⁺) as a monovalent metal ion. The lithium salt may include CH₃COOLi, LiX (where, X denotes F, Cl, Br or I), LiNO₃, LiOH, LiOR (where, R represents an alkyl group having 1 to 5 carbon atoms) and the like. These lithium salts may be used alone or in combination of two or more thereof. When the metal salt is a magnesium salt containing a magnesium ion (Mg²⁺) as a divalent metal ion, the magnesium salt may be (CH₃COO)₂Mg, MgX₂ (where, X represents F, Cl, Br or I), or the like.

The organic solvent ionizes the metal salt compound to provide metal ions from the metal salt compound. The organic solvent may be a protic solvent or a polar aprotic solvent. Examples of the organic solvent may include dimethylsulfoxide (DMSO), N,N-dimethylformamide, N-methyl formamide, methanol, ethanol, isopropanol, 2-methoxyethanol, water and the like. These solvents may be used alone or in combination of two or more thereof.

The precursor solution in which the framework compound, the metal salt and the organic solvent are mixed may be heated at a predetermined temperature. For example, the precursor solution may be heated at a temperature between 40° C. and 150° C. before the precursor solution is used in a subsequent solution process. In this heating process, the components of the precursor solution may react with each other to form a precursor material that partially replicates a lattice structure of the metal-phosphorus-oxynitride.

The precursor solution as prepared is subjected to a solution process to form a precursor film (S200).

The precursor solution is coated on a base to form the precursor film thereon. The solution process may be performed using spray coating, dip coating, spin coating, inkjet printing, offset printing, reverse offset printing, gravure printing, roll printing, etc.

In this connection, the base may be a particulate electrode, a three-dimensional porous structure, or a plate-like substrate. In one example, when the base is embodied as a substrate, a metal substrate, a semiconductor substrate, a glass substrate, a polymer substrate such as a plastic, a paper, a textile substrate, etc. may employed. The precursor film may be formed on at least one face of the base. In another example, when the base is a particulate electrode or a three-dimensional porous structure, the precursor film may be formed on a face of the base by immersing the particulate electrode or three-dimensional porous structure into the precursor solution.

The solution process may be performed in an inert atmosphere, such as nitrogen or argon, or in a dry air atmosphere with a relative humidity lower than or equal to 5%.

After the precursor film is formed on the base, a solvent removal process may be performed before a heat treatment process for forming a coated film. The solvent removal process is a heat treatment process performed at a lower temperature than a temperature at the heat treatment process for forming the coated film. A temperature at the solvent removal process may be controlled depending on a type of the organic solvent used in the production of the precursor solution. The solvent removal process may be carried out at a temperature close to a boiling point of the organic solvent, for example, in a range of from 40° C. to 150° C. The solvent removal process may reduce a mechanical stress of the ionic conductive film due to volume reduction after the subsequent heat treatment process to form the coated film. Accordingly, the coated film uniformly distributed over the base may be formed. The solvent removal process may be performed in an inert atmosphere, such as nitrogen or argon, or in a dry air atmosphere with a relative humidity lower than or equal to 5%.

Then, the precursor film may be heat-treated to form the metal-phosphorus-oxynitride film (S300). Thus, the coated film made of metal-phosphorus-oxynitride may be formed.

In the heat treatment process, the components constituting the precursor film have a heated and polymerization reaction to form metal-phosphorus-oxynitride, and thus the coated film is formed. The heated and polymerization reaction may involve ring-opening reaction, condensation reaction, and/or polymerization reaction of the components constituting the precursor film such that metal-phosphorus-oxynitride is formed in which phosphorus and nitrogen are mixed. In this connection, one nitrogen bonds with two or three atoms to form a P—N—O bond. In the heat treatment process, the heated and polymerization reaction occurs, and, at the same time, unnecessary impurities may be removed via heat. The impurities may include carbon, hydrogen, chlorine, etc., contained in the precursor solution.

The heat treatment process may be performed in an inert atmosphere, such as nitrogen or argon, or in a dry air atmosphere with a relative humidity lower than or equal to 5%. The heat treatment process may be performed at 150° C. to 500° C. Further, it is preferable that the heat treatment process is performed for at least 5 minutes or larger. In one example, the heat treatment process may be performed for 5 minutes to 1 hour.

The metal-phosphorus-oxynitride contained in the coated film includes a chemical structure represented by following Chemical Formula 1-1 and/or 1-2, which allows the metal-phosphorus-oxynitride to have an amorphous phase. In this connection, Mⁿ⁺ in each of the following Chemical Formulas 1-1 and 1-2 represents a monovalent, divalent or trivalent metal ion. That is, M represents a type of the metal, and n represents an integer of 1 to 3. Thus, Mⁿ⁺ may represent Li⁺, Mg²⁺, Al³⁺ or the like.

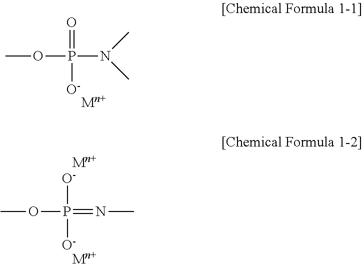

The chemical structure of the Chemical Formula 1-1 is a partial chemical structure containing a P—N bond. In this connection, when a monovalent ion is contained, this structure is M⁺[PO₂O_{1/2}N_{1/3}]⁻. When a divalent ion is contained, this structure is M²⁺.2[PO₂O_{1/2}N_{1/3}]⁻. When a trivalent ion is contained, this structure is M³⁺.3[PO₂O_{1/2}N_{1/3}]⁻. The chemical structure represented by the Chemical Formula 1-1 may be connected to P of M_{1/n}PO₃ form two P—N bonds. Thus, a P—N—P bond may be formed. Further, O⁻ is bound to Mⁿ⁺ and O_{1/2} is bound to another P to form a P—O—P bond.

The chemical structure of the Chemical Formula 1-2 is a chemical structure containing P═N bond. This structure is 2M⁺[PO₂O_{1/2}N_{1/2}]²⁻ when a monovalent ion is contained. When a divalent ion is contained, this structure is M²⁺[PO₂O_{1/2}N_{1/2}]²⁻. When a trivalent ion is contained, this structure is 2M³⁺.3[PO₂O_{1/2}N_{1/3}]²⁻. The chemical structure represented by the Chemical Formula 1-2 may be connected to P of M₂PO₃ to further form one P—N bond, thus, to form a P═N—P bond. In the chemical structure of the Chemical Formula 1-2, O⁻ is bound to Mⁿ⁺ and O_{1/2} is bound to another P to form a P—O—P bond.

The metal-phosphorus-oxynitride containing the chemical structure represented by the Chemical Formula 1-1 and/or Chemical Formula 1-2 may be easily produced even in the non-vacuum state by preparing the precursor solution, coating the precursor solution on the base via a solution process, and performing a heat treatment process of the precursor film.

The step S100, step S200, and step S300 as described in FIG. 1 are sequentially performed to form a single-layered thin coated film. While the first coated film has been formed, the method may perform the steps S200 and S300 again to form a second coated film on the first coated film. In this way, repeating of the steps S200 and S300 may allow a plurality of coated films to be stacked on the base to form a thick ionic conductive film. That is, the thickness of the ionic conductive film may be easily controlled by controlling the number of repetitions of the process of forming a single coated film.

In one embodiment, in the process of preparing the precursor solution in S100, a chalcogen compound may be further mixed with the framework compound, the metal salt and the organic solvent. The chalcogen compound is a compound comprising S, Se and/or Te. Examples of the chalcogen compound may include Li₂S, LiHS, LiHSe, Li₂Te, LiHTe, H₂S, H₂Se, H₂Te, etc. Mixing the chalcogen compound with the framework compound, the metal salt and the organic solvent may allow the ionic conductive film to contain a P—N-Q or P-Q bond.

That is, when the precursor solution further contains the chalcogen compound, the ionic conductive film may contain the chemical structure represented by the Chemical Formula 1-1 and/or 1-2 as the metal-phosphorus-oxynitride, and, further, a metal-phosphorus-chalcogen nitride as a derivative of the metal-phosphorus-oxynitride. The metal-phosphorus-chalcogen nitride as a derivative of the metal-phosphorus-oxynitride may include a chemical structure of Chemical Formula 2-1 and/or 2-2 below:

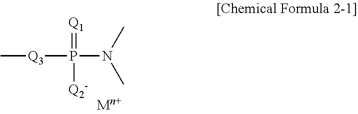

In the Chemical Formula 2-1, Mⁿ⁺ represents a monovalent, divalent or trivalent metal ion. Each of Q₁, Q₂ and Q₃ independently represents O, S, Se or Te, except that all of Q₁, Q₂ and Q₃ represent O at the same time.

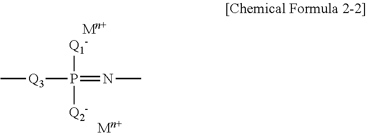

In the Chemical Formula 2-2, Mⁿ⁺ represents a monovalent, divalent or trivalent metal ion. Each of Q₁, Q₂ and Q₃ independently represents O, S, Se or Te, except that all of Q₁, Q₂ and Q₃ represent O at the same time.

The chemical structure of the Chemical Formula 2-1 is a chemical structure containing a P—N bond. In this connection, N bonds to another P to further form two P—N bonds, thus to form a P-Q-P bond. Further, the chemical structure of Chemical Formula 2-2 includes P═N. In this connection, N bonds with another P to further form one P—N bond, thus to form a P═N—P bond.

The ionic conductive film as produced by the method for producing the ionic conductive film as described above may be applied as solid electrolyte for a secondary battery, a thin film battery, a lithium-sulfur or sodium-sulfur battery, and an all-solid battery using a metal ion such as lithium ion. The ionic conductive film as produced by the method may be used as a solid interface layer for preventing the growth of lithium dendrite in a high energy density battery using the lithium ion as an anode material. Further, the ionic conductive film as produced by the production method according to the present disclosure may be used as ionic conductive electrolyte for an electrochromic device, an ultra-high dielectric constant insulator for an electronic device such as a thin film transistor, or the like. In addition, the ionic conductive film may be used as solid electrolyte replacing low-reliability liquid electrolytes in supercapacitors.

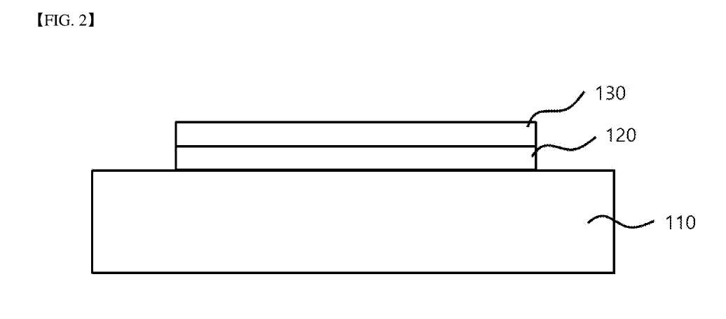

FIG. 2 is a cross-sectional view of a capacitor for illustrating a method for producing the capacitor according to one embodiment of the present disclosure.

Referring to FIG. 2, a capacitor includes a base substrate 110, an ionic conductive film 120, and an electrode layer 130. The ionic conductive film 120 may be produced using the method as described in FIG. 1.

The base substrate 110 may be a conductive substrate and may act as a counter electrode to the electrode layer 130. Alternatively, the base substrate 110 may have a structure including an insulating substrate and an electrode layer formed thereon.

The ionic conductive film 120 is formed on the base substrate 110. To this end, according to the method as described in FIG. 1, the precursor solution is prepared, and, then, the precursor film is formed on the substrate 110 via the solution process, and, then, the precursor film is subjected to the heat treatment, thereby to form the ionic conductive film 120. In order to allow the ionic conductive film 120 applied to the capacitor to be thicker, at least two coated films may be stacked. To this end, the step of forming the precursor film may be repeated at least two times and the heat treatment process of the precursor film may be repeated at least two times. In this connection, a single step of forming the precursor film and a single heat treatment process may form one cycle. The thus-produced ionic conductive film 120 may be made of the metal-phosphorus-oxynitride including the chemical structure of the Chemical Formulas 1-1 and/or 1-2. In some examples, adding the chalcogen compound to the precursor solution may allow the thus-produced ionic conductive film 120 to include the derivative of the metal-phosphorus-oxynitride, where the derivative includes the chemical structure of the Chemical Formula 2-1 and/or 2-2.

The electrode layer 130 is formed on the ionic conductive film 120. The electrode layer 130 may be made of an electrode material such as gold, copper, silver, aluminum, conductive polymer, carbon nanotube, or graphene. The electrode layer 130 may be formed via vacuum deposition of the electrode material. Alternatively, the electrode layer 130 may be formed via a solution process of the electrode material.

Hereinafter, the above-described method for producing the ionic conductive film will be described in more detail using specific Present Examples. Characteristics of the ionic conductive film thus produced will be described in detail. The Present Examples as described below are intended to illustrate the present disclosure and does not limit the present disclosure.

### Present Example 1: Production of Sample 1

For preparation of a precursor solution with a lithium:phosphorus atomic ratio of 0.5:1, 0.3M hexachlorophosphazene and 0.45M lithium hydroxide hydrate were dissolved in 2-methoxyethanol together with heating at 70° C. for 12 hours to prepare the precursor solution.

The precursor solution was spin coated on a heavily p-doped silicon wafer under an inert atmosphere to form a precursor film. The precursor film was heat treated for 1 min at 70° C. in an inert nitrogen atmosphere to remove the solvent from the precursor film.

The solvent-free precursor film was heat-treated at 500° C. under an inert nitrogen atmosphere to form a first coated film.

After the heat treatment at 500° C., the precursor solution was again spin-coated on the first coated film. A first heat treatment for the solvent removal at 70° C. was performed and then a second heat treatment at 500° C. was performed to form a second coated film on the first coated film. Thus, a 150 nm ionic conductive film was produced as a sample 1 as produced according to Present Example 1 of the present disclosure.

### Present Example 2: Production of Sample 2

Sample 2 in accordance with Present Example 2 of the present disclosure was produced in substantially the same manner as described in Present Example 1 except for contents of the framework compound and metal salt used in the preparation of the precursor solution.

The precursor solution used in the production of the sample 2 was produced using 0.3M hexachlorophosphazene and 0.6M lithium hydroxide hydrate so that the atomic ratio between lithium and phosphorus was 0.66:1. A thickness of the ionic conductive film in the sample 2 was 200 nm.

### Present Example 3: Production of Sample 3

Sample 3 in accordance with Present Example 3 of the present disclosure was produced in substantially the same manner as described in Present Example 1 except for contents and types of the framework compound and metal salt used in the preparation of the precursor solution.

The precursor solution used in the production of the sample 3 was produced using 0.9M poly(dichlorophosphazene) and 0.6M lithium hydroxide hydrate so that the atomic ratio between lithium and phosphorus was 0.66:1. A thickness of the ionic conductive film in the sample 3 was 110 nm.

### Present Example 4: Production of Sample 4

Sample 4 in accordance with Present Example 4 of the present disclosure was produced in substantially the same manner as described in Present Example 3 except for contents of the framework compound and metal salt used in the preparation of the precursor solution.

The precursor solution used in the production of the sample 4 was produced using 0.9M poly(dichlorophosphazene) and 0.75M lithium hydroxide hydrate so that the atomic ratio between lithium and phosphorus was 0.83:1. A thickness of the ionic conductive film in the sample 4 was 130 nm.

### Present Example 5: Production of Sample 5

Sample 5 in accordance with Present Example 5 of the present disclosure was produced in substantially the same manner as described in Present Example 3 except for contents of the framework compound and metal salt used in the preparation of the precursor solution.

The precursor solution used in the production of the sample 5 was produced using 0.9M poly(dichlorophosphazene) and 0.90M lithium hydroxide hydrate so that the atomic ratio between lithium and phosphorus was 1:1. A thickness of the ionic conductive film in the sample 5 was 150 nm.

Evaluation of Surface Roughness Characteristics

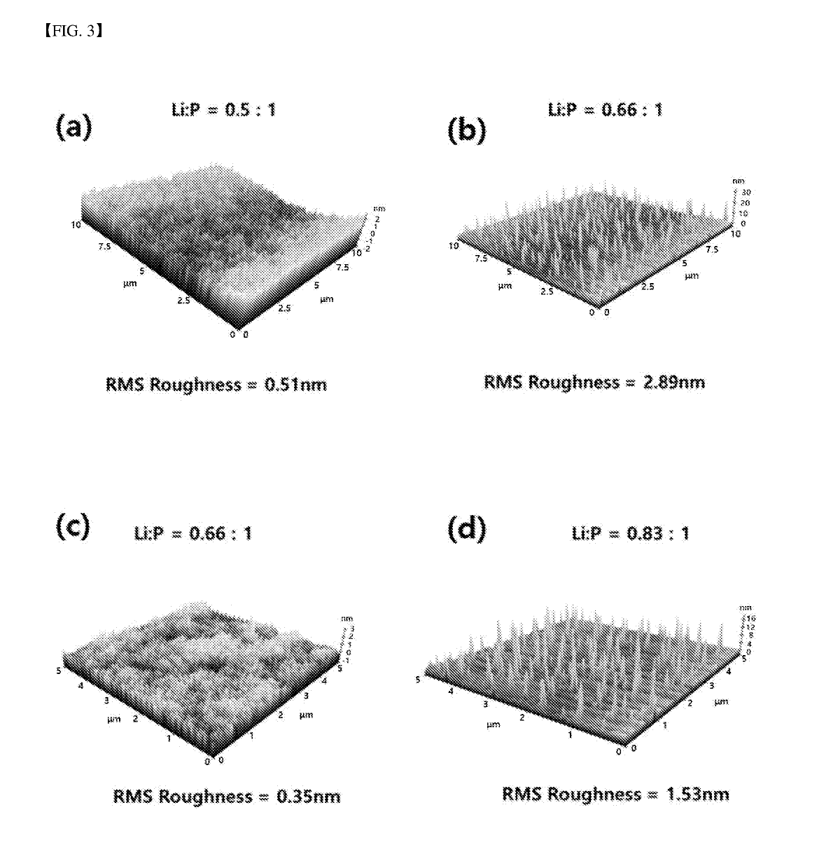

An image of each of the prepared sample 1 to sample 4 was taken using an atomic force microscope. A surface roughness value was deduced from the image analysis. Results are shown in FIG. 3.

FIG. 3 shows atomic force microscope images of the sample 1 to sample 4 as produced according to the present disclosure.

In FIG. 3, (a) is a surface roughness analysis result of the sample 1, (b) is a surface roughness analysis result of the sample 2, (c) is a surface roughness analysis result of the sample 3, and (d) is a surface roughness analysis result of the sample 4.

Referring to FIG. 3, the surface roughness of the sample 1 is 0.51 nm, the surface roughness of the sample 2 is 2.89 nm, the surface roughness of the sample 3 is 0.35 nm, and the surface roughness of the sample 4 is 1.53 nm. It may be confirmed from this result that a homogeneous thin film without holes could be formed via the solution process.

Capacitor Production and Characteristics Evaluation Thereof-1

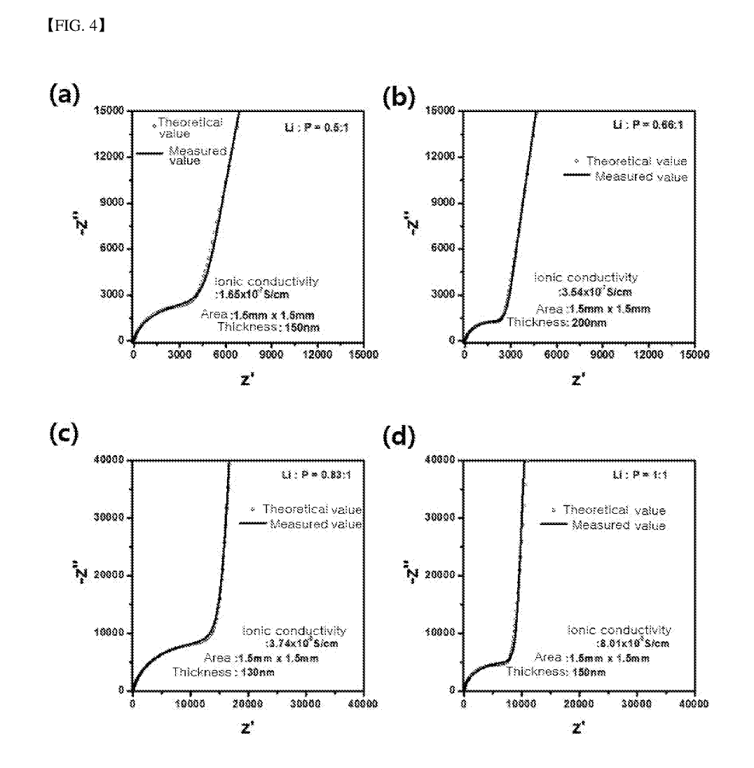

Each capacitor was prepared by forming a gold electrode pattern on each of the samples 1, 2, 4, and 5 using a shadow mask. An impedance thereof was measured. A result is shown in FIG. 4.

FIG. 4 shows impedance measurements of the capacitors as produced using samples 1, 2, 4 and 5 as produced according to the present disclosure.

In FIG. 4, (a), (b), (c), and (d), respectively, refer to impedance measurements of the capacitors produced using the samples 1, 2, 4, and 5. Further, ionic conductivity values as derived from the impedance measurements of the capacitors are also indicated.

FIG. 4 shows that the ionic conductivity of each of the sample 1 and sample 2 is larger than 10⁻⁷ S/cm, and that the ionic conductivity of each of the sample 4 and sample 5 is substantially equal to 10⁻⁸ S/cm. Thus, it may be confirmed that the solution-phase precursor that partially replicates the lattice structure of the metal-phosphorus-oxynitride containing the P—N or P═N bond forms the ionic conductive metal-phosphorus-oxynitride. Further, it may be confirmed that the ionic conductivity may be controlled via controlling the chemical compositions.

### Present Examples 6 and 7: Production of Sample 6 and Sample 7

A precursor solution having an atomic ratio of lithium and phosphorus of 0.33:1 was prepared using 0.3M hexachlorophosphazene and 0.3M lithium acetate. Then, the sample 6 was prepared via a process substantially identical to the production process of the sample 1 according to Present Example 1 except that the second heat treatment process was performed at 300° C.

Further, the sample 7 was prepared via substantially the same process as the production process of the sample 6, except that the second heat treatment process was performed at 500° C.

Structural Analysis-1

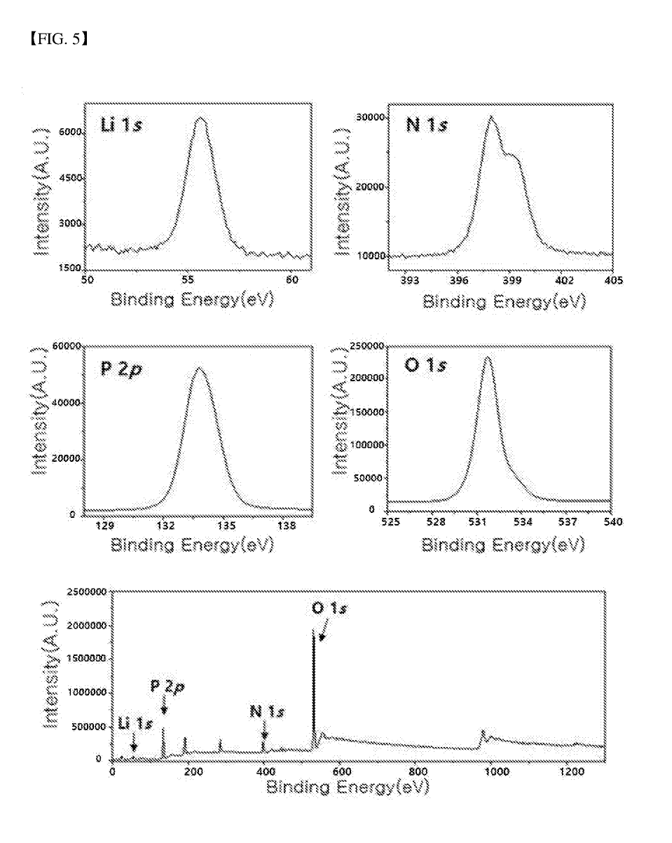

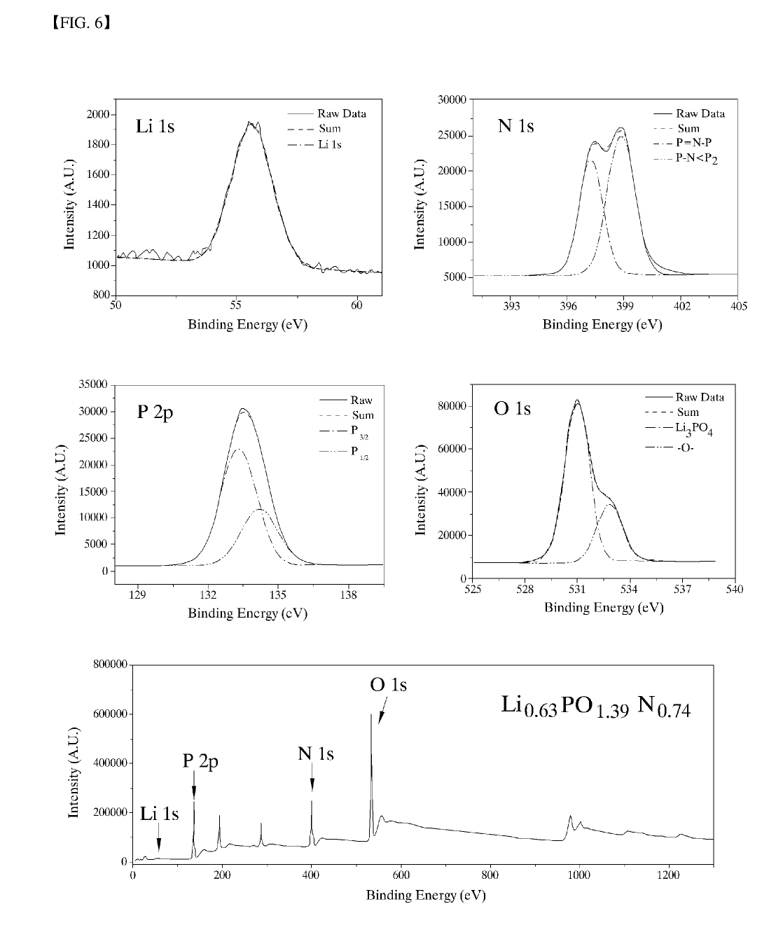

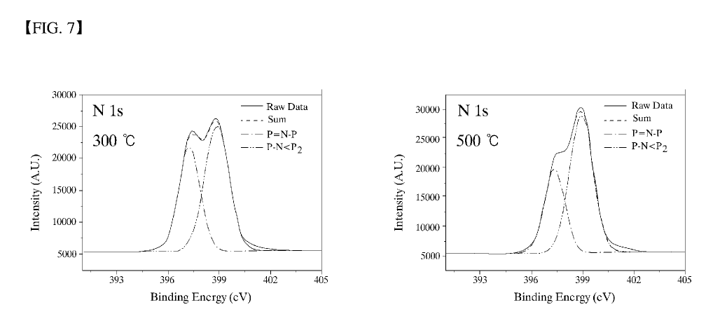

In order to analyze the structure of the produced ionic conductive films, the analysis of lithium, phosphorus, nitrogen and oxygen for the sample 1, sample 5 and sample 6 was carried out by X-ray photoelectron spectroscopy (XPS). Results are shown in FIG. 5, FIG. 6 and FIG. 7.

FIG. 5 and FIG. 6 show the structural analysis results of the sample 1 and sample 5 as produced according to the present disclosure. FIG. 7 shows N 1s analysis results of the sample 6 and sample 7 as produced according to the present disclosure.

Referring to FIG. 5 and FIG. 6, it may be seen that Li, N, and O are present in the sample 1 and sample 5. Thus, it may be confirmed that the lithium-phosphorus-oxynitride is formed via the solution process. Chemical formulas showing compositions of the sample 1 and sample 5 are Li_{1.53}PO_{2.27}N_{0.40} and Li_{0.63}PO_{1.39}N_{0.74} respectively by way of example.

FIG. 7 shows a difference between the ionic conductive films as produced under substantially the same condition except for the temperature of the heat treatment process. That is, a proportion of N atoms bonded to three atoms due to the ring opening reaction during the heat treatment process is higher in the ionic conductive film resulting from the heat treatment at 500° C. than in the ionic conductive film resulting from the heat treatment at 300° C.

Structural Analysis-2

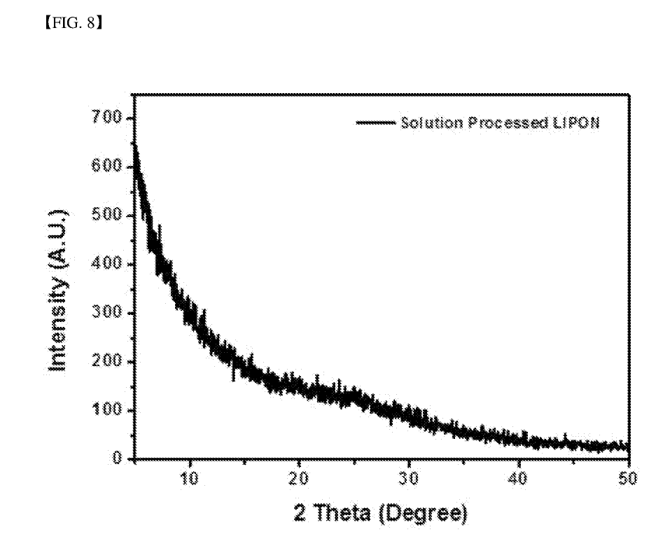

X-ray diffraction analysis was performed on the sample 7. The result is shown in FIG. 8.

FIG. 8 shows a result of X-ray diffraction analysis for the sample 7 as produced according to the present disclosure.

With reference to FIG. 8, the X-ray diffraction analysis informs that the lithium-phosphorus-oxynitride as produced has an amorphous phase.

### Present Example 8: Production of Sample 8

To produce a precursor solution with an atomic ratio of lithium:phosphorus of 0.5:1, 0.9M poly(dichlorophosphazene) and corresponding content of lithium hydroxide hydrate were dissolved in dimethylsulfoxide (DMSO). Then, the sample 8 according to Present Example 8 was produced by performing substantially the same process as the production process of the sample 1 except that the first heat treatment process for removing the organic solvent was omitted after the coating of the precursor solution, and the second heat treatment was performed at 300° C. for 30 minutes.

### Present Example 9: Production of Sample 9

To prepare a precursor solution with an atomic ratio of lithium:phosphorus:sulfur of 6:9:1, 0.3M hexachlorophosphazene, 0.2M lithium hydroxide hydrate and 0.2M Li₂S were mixed in ethanol. Then, the sample 9 was produced according to Present Example 9 by performing substantially the same process as the production process of the sample 1 except for the composition of the precursor solution.

### Present Example 10: Production of Sample 10

To prepare a precursor solution with an atomic ratio of lithium:phosphorus:sulfur of 2:2:1, 0.3M hexachlorophosphazene and 0.45M Li₂S were mixed in ethanol. Then, the sample 10 according to Present Example 10 was produced by performing substantially the same process as that of the sample 1 except for the composition of the precursor solution and except that the second heat treatment process was performed at 300° C.

Structural Analysis-3

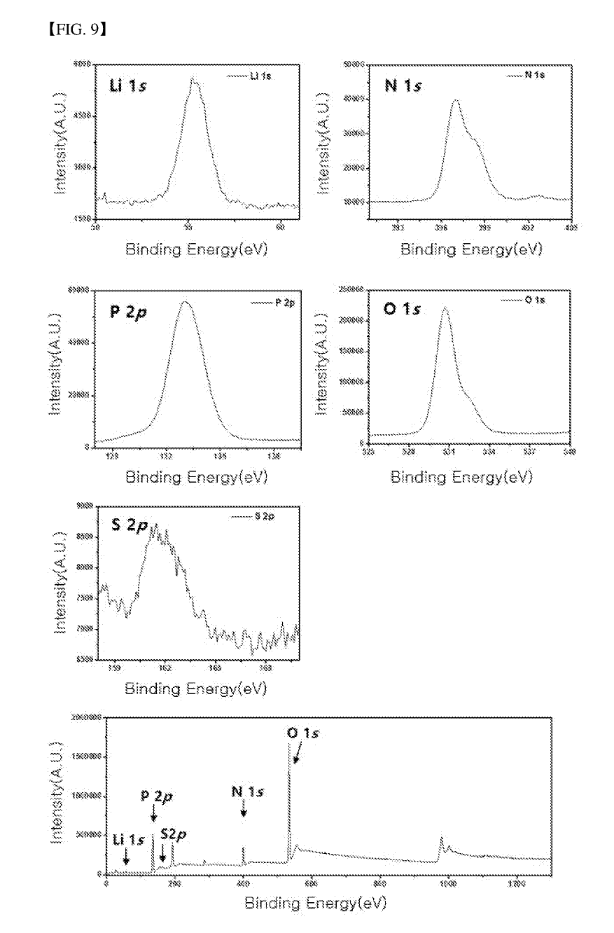

In order to analyze the structure of the produced ionic conductive film of the sample 9, X-ray photoelectron spectroscopy (XPS) was used to analyze lithium, phosphorus, nitrogen and oxygen in the sample 9. A result is shown in FIG. 9.

FIG. 9 shows a result of the structural analysis of the sample 9 as produced according to the present disclosure.

Referring to FIG. 9, it may be seen that Li, N, O and S are present in the sample 9. Further, it may be confirmed that the lithium-phosphorus-sulfur oxynitride is formed via the solution process.

Production of Capacitor and Evaluation of Characteristic Thereof-2

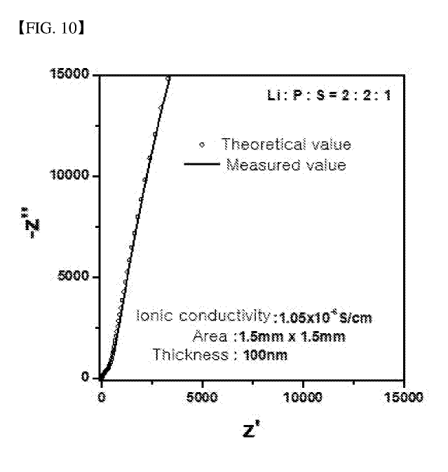

A capacitor was prepared by forming a gold electrode pattern on the sample 10 using a shadow mask. An impedance thereof was measured. A result is shown in FIG. 10.

FIG. 10 shows an impedance measurement of the capacitor fabricated using the sample 10 as produced according to the present disclosure.

As shown in FIG. 10, it may be seen that the ionic conductivity of the capacitor fabricated using sample 10 has a very high value, that is, about 10⁻⁶ S/cm.

The description of the disclosed embodiments is provided to enable any person skilled in the art to make or use the present disclosure. Various modifications to these embodiments will be readily apparent to those skilled in the art of the present disclosure. The general principles defined herein may be applied to other embodiments without departing from the scope of the present disclosure. Thus, the present disclosure is not to be construed as limited to the embodiments set forth herein but rather to be accorded the widest scope consistent with the principles and novel features set forth herein.

What is claimed is:

1. A method for producing an ionic conductive film, the method comprising:
preparing a precursor solution, wherein the precursor solution contains a framework compound having a single bond or double bond between phosphorus (P) and nitrogen (N), a metal salt compound, and an organic solvent;
preforming a solution process of the precursor solution in a non-vacuum condition to form a precursor film on a base; and
preforming a heat-treating process of the precursor film to form a coated film containing metal-phosphorus-oxynitride.

2. The method of claim 1, wherein the solution process includes coating the precursor solution on the base using at least one selected from a group consisting of spray coating, spin coating, dip coating, inkjet printing, offset printing, reverse offset printing, gravure printing and roll printing.

3. The method of claim 1, wherein the method further comprises, after preparing the precursor solution and before the solution process, heating the precursor solution.

4. The method of claim 1, wherein the heat-treating process is carried out at a temperature in a range of from 150° C. to 500° C.

5. The method of claim 1, wherein each of the solution process and the heat-treating process is carried out under a dry air atmosphere or an inert gas atmosphere.

6. The method of claim 1, wherein the method further comprises, before the heat-treating process, removing the organic solvent from the precursor film by heating the precursor film to a temperature lower than a temperature of the heat-treating process.

7. The method of claim 1, wherein the base includes a particulate substrate, a three-dimensional porous structure or a plate-like substrate.

8. The method of claim 1, wherein a cycle including the solution process and the heat-treating process is repeated such that a plurality of the coated films are stacked vertically.

9. The method of claim 1, wherein the coated film has an amorphous phase containing a phosphorus (P)-oxygen (O)-phosphorous (P) bond and a phosphorus (P)-nitrogen (N)-phosphorous (P) bond.

10. The method of claim 1, wherein the preparation of the precursor solution includes mixing a chalcogen compound with the framework compound, the metal salt compound and the organic solvent to form the precursor solution,
wherein the coated film contains the metal-phosphorus-oxynitride, and metal-phosphorus-chalcogen nitride.

11. The method of claim 10, wherein the coated film has an amorphous phase containing a phosphorus (P)-oxygen (O)-phosphorous (P) bond, a phosphorus (P)-nitrogen (N)-phosphorous (P) bond, and a phosphorus (P)-chalcogen element (C)-phosphorous (P) bond.
